(19) United States
(12) Patent Application Publication
(10) Pub. No.: US 2017/0001516 A1
(43) Pub. Date: Jan. 5, 2017

(54) FILLING APPARATUS FOR A VEHICLE TANK

(71) Applicant: ILLINOIS TOOL WORKS INC., Glenview, IL (US)

(72) Inventor: Christian BECK, Roettingen (DE)

(21) Appl. No.: 15/106,852

(22) PCT Filed: Dec. 12, 2014
(86) PCT No.: PCT/US2014/070073

§ 371 Date: Jun. 21, 2016

(30) Foreign Application Priority Data
Jan. 10, 2014 (DE) 10 2014 100 248.2

(51) Int. Cl. B60K 15/04; F16L 23/04; F16L 37/252

(52) U.S. Cl. CPC B60K 15/0406; F16L 37/252; F16L 23/04; B60K 2015/03453

(57) ABSTRACT

The invention relates to a filling apparatus for a vehicle tank, comprising a filling head, through which a liquid to be filled into the vehicle tank can be filled and on the outer side of which a fastening flange is provided, wherein a fastening device is provided, by way of which the filling head can be fastened releasably to a filling pipe which is connected to the vehicle tank, the fastening device comprising a fastening ring which is formed from two ring halves, it being possible for the ring halves to be adjusted between an open position and a closed position, the ring halves holding the fastening flange of the filling head and a fastening flange of the filling pipe between them in the closed position, and the ring halves releasing the fastening flange of the filling head and the fastening flange of the filling pipe in the open position for releasing the filling head from the filling pipe.

The invention relates to a filling apparatus for a vehicle tank, comprising a filling head, through which a liquid to be filled into the vehicle tank can be filled and on the outer side of which a fastening flange is provided. Filling apparatuses of this type for filling a vehicle tank with fuel have a filling head which serves for introducing and hooking a fuel pump nozzle into place. For this purpose, the filling head is connected to a filling pipe leading to the vehicle tank. It is known to weld the filling head to the filling pipe or to crimp the filling head thereto by means of a crimping tool. In addition, it is known to fasten, for example to crimp, a metal connecting part, for example a metal head, to the filling head. There is then a secure connection which is adequately tight both against the passage of liquid and fuel vapors, optionally in conjunction with a corresponding seal.

It is disadvantageous that, because of the nonreleasable connection between filling head and filling pipe, the entire vehicle tank frequently has to be removed and replaced during a required repair of the filling head, which can be very complicated and is associated with high costs. Furthermore, filling heads are designed differently for different types of fuel, for example diesel fuel and gasoline fuel. As a result, numerous variants are produced at the vehicle tank manufacturer, since the different filling heads are generally already fastened there to the vehicle tank or to the filling pipe. The tank manufacturers and the vehicle manufacturers currently do not have a standard interface on the filling head.

Starting from the explained prior art, the invention is based on the object of providing a filling apparatus of the type mentioned at the beginning, with which, with a secure connection between filling head and filling pipe, the complexity in the initial assembly and in a subsequent repair or a replacement is reduced.

The invention achieves the object by the subject matter of claim 1. Advantageous refinements are found in the dependent claims, the description and the figures.

For a filling apparatus of the type mentioned at the beginning, the invention achieves the object in that a fastening device is provided, by way of which the filling head can be fastened releasably to a filling pipe which is connected to the vehicle tank, the fastening device comprising a fastening ring which is formed from two ring halves, it being possible for the ring halves to be adjusted between an open position and a closed position, the ring halves holding the fastening flange of the filling head and a fastening flange of the filling pipe between them in the closed position, and the ring halves releasing the fastening flange of the filling head and the fastening flange of the filling pipe in the open position for releasing the filling head from the filling pipe. The filling apparatus according to the invention can also comprise the filling pipe and/or the vehicle tank. In addition, a metal connecting part, for example a metal head, can be fastened to the filling head, for example by crimping. Such a metal connecting part can also be fastened releasably to the filling head.

A liquid, for example fuel or a urea solution for selective catalytic reduction (SCR), is filled into the vehicle tank in a manner known per se via the filling head. For this purpose, for example, a fuel pump nozzle can be introduced into the filling head and hooked in place. The filling head has an encircling fastening flange, in particular on the outer surface thereof. The fastening flange can be formed at an end of a tubular section of the filling head, which end faces the filling pipe in the mounted state. However, it is also possible for the fastening flange to be located on the outer side of a tubular section between the ends of the filling head. In order to improve the stability, the tubular section can then be inserted with a section, which is located between its end facing the filling pipe and the fastening flange, into the filling pipe. The filling pipe likewise has an encircling fastening flange, in particular on the outer surface thereof. Said fastening flange can be formed, for example, at an end of the filling pipe, which end faces the filling head in the mounted stated. However, it is also possible for the fastening flange to be located on the outer side of the filling pipe between the ends of the filling pipe. In this case, in order to improve stability, the filling pipe can be inserted with a section, which is located between its end facing the filling head and the fastening flange, into the filling head.

According to the invention, a releasable fastening of the filling head to the filling pipe is therefore realized. A fastening device with a fastening ring formed from two ring halves serves for this purpose. The ring halves can be adjusted or moved between an open position and a closed position. This can take place repeatedly, in principle as often as desired. In the open position, the ring halves do not form a closed ring, and therefore the fastening flanges of the filling head and of the filling pipe can be introduced between the ring halves. The ring halves can subsequently be moved toward each other in such a manner that they form a closed ring. The fastening flanges are then caught between the ring halves, and the filling head and the filling pipe are therefore fastened to each other. The ring halves in particular form half shells, and therefore they receive and securely hold the fastening flanges between them.

The ring halves can press the fastening flange of the filling head and the fastening flange of the filling pipe against one another in the closed position. This realizes a connection which is particularly secure and, in particular in conjunction with a suitable seal, is tight against the passage of liquid and/or gases. The ring halves can in each case have, for example, a U-shaped cross section. The position of the ring halves in which they form a closed ring can form a pre-closure position, in which the fastening flanges are not yet pressed against each other. From said pre-closure position, the ring halves can then be adjusted into the closed position, in which the fastening flanges are pressed against each other.

According to the invention, a serviceable fastening of the filling head to the filling pipe is achieved. At the same time, there is high flexibility in respect of the use for different fuels. The mounting of the filling head on the filling pipe can take place in an advantageous manner on the vehicle with the tank already mounted. The vehicle manufacturers can therefore be supplied with standard vehicle tanks by the tank manufacturers, wherein the adaptation to the liquid to be inserted in each case does not have to take place until during the mounting of the filling head at the vehicle manufacturer. If a repair is required, the filling pipe or even the entire vehicle tank does not have to be removed, but rather the connection between the filling head and the filling pipe can be released in a simple manner and the filling head repaired or replaced for another filling head. Standard repair solutions with correspondingly lower costs are possible.

In particular in the pre-closure position explained, the ring halves can be connected to one another by a latching connection. The latching connection forms a releasable fastening of the ring halves to one another in a manner which is particularly simple to fit and to remove. According to a further refinement, it can be provided that the ring halves comprise in each case one latching lug which is formed at their one free end and in each case one latching receptacle which is formed at their other free end, the latching lugs being received in a latching manner in the latching receptacles in order to connect the ring halves. The free ends here are those ends or end sides of the ring halves which face one another in the connected state of the ring halves.

The ring halves can therefore be separate components which are completely separated from one another in the open position. However, this is not imperative. It is also conceivable for the ring halves to be connected to one another pivotably. The ring halves can be pivoted with respect to one another by the pivoting connection between the open position and, in particular, the pre-closure position. The pivotable connection can be realized by a hinge, for example a film hinge. An integral or separate configuration is possible here. The pivoting connection, for example a hinge, can be an integral part of one or both or neither of the ring halves. It is furthermore possible that one of the ring halves has a latching lug at its free end, and that the other of the ring halves has a latching receptacle at its free end, in which latching receptacle the latching lug can be received in a latching manner in order to connect the ring halves. In this case, the ring halves have only one free end, whereas the other end is connected in each case to the hinge or to a similar pivoting connection.

According to a further refinement which further simplifies the production and the handling and mounting, the ring halves can be of identical configuration.

According to a further particularly practical refinement, it can be provided that the ring halves interact in the closed position in the manner of a bayonet closure with the fastening flange of the filling head and/or the fastening flange of the filling pipe. In order to reach the closed position, for example from the pre-closure position, the ring halves forming the closed fastening rings, and the filling head and/or the filling pipe can then be rotated relative to one another. Components of the bayonet closure are formed here on the fastening flange of the filling head and/or of the filling pipe, with which the ring halves interact as a counterpart of the bayonet closure. During the rotation, the fastening flanges of filling head and filling pipe are in particular pressed against each other and therefore the fastening ring is securely locked to the fastening flanges. For release purposes, the ring halves forming the closed fastening ring, and the filling head or the filling pipe are rotated in the opposite direction to one another. As a result, the bayonet closure is detached and the ring halves can be adjusted from their pre-closure position, which is then adopted, into their open position such that the filling head can be released from the filling pipe.

In order to realize the bayonet closure, it can be provided that the ring halves have at least one pressing ramp with at least one locking recess which adjoins the at least one pressing ramp, and that the fastening flange of the filling head and/or the fastening flange of the filling pipe have/has at least one locking projection which is received in the at least one locking recess in the closed position.

Alternatively or in addition, it can be provided that the fastening flange of the filling head and/or the fastening flange of the filling pipe have/has at least one pressing ramp with at least one locking recess which adjoins the at least one pressing ramp, and that the ring halves have at least one locking projection which is received in the at least one locking recess in the closed position. A plurality of pressing ramps, each having a locking recess, and, correspondingly, a plurality of corresponding locking projections can be provided in each case here. Furthermore, it can be provided that the ring halves have at least one pressing cam which is pressed against the fastening flange of the filling head and/or the fastening flange of the filling pipe in the closed position, and/or that the fastening flange of the filling head and/or the fastening flange of the filling pipe have/has at least one pressing cam which is pressed against the ring halves in the closed position. A plurality of pressing cams of this type can in turn be provided. The pressing ramps and the pressing cams ensure that the fastening flanges of filling head and filling pipe are pressed against each other in the closed position. The pressing ramps with the locking recesses and the corresponding locking projections can be formed in particular on mutually opposite inner sides of the ring halves, which form the fastening ring, on the one hand, and upper and/or lower sides of the fastening flange or fastening flanges, on the other hand. For example, the pressing ramps with the locking recesses and the corresponding locking projections can be formed on an upper side of the fastening flange of the filling head, which upper side faces away from the fastening flange of the filling pipe, and on an inner side of the ring halves forming the fastening ring, which inner side faces said upper side. The pressing cams can also be formed, for example, on an upper side of the fastening flange of the filling head, which upper side faces away from the fastening flange of the filling pipe, and/or on an inner side of the ring halves forming the fastening ring, which inner side filling-head faces said upper side.

A seal can be arranged between the fastening flange of the filling head and the fastening flange of the filling pipe at least in the closed position. The seal can be, for example, a sealing ring which, in the closed position, is pressed between the fastening flanges such that the connection between filling head and filling pipe is sealed to the outside against passage of liquid and/or gases. The seal is compressed in the closed position. The sealing ring then in particular forms an axial seal. Of course, other seals are also conceivable, such as radial seals, for example a sealing ring (for example O ring) arranged between a filling-head inner or outer surface and a filling-pipe outer or inner surface facing said filling-head inner or outer surface.

The filling head can be a filling head with a conventional closure cap which has to be released, for example by unscrewing, by a user before the refueling operation. Alternatively, the filling head can also be a capless filling head which does not have a closure cap to be released manually, but rather has a flap or the like which opens during the introduction of a pump nozzle. The filling head can also be a filling head with or without a mis-fuel-inhibitor (MFI).

The filling pipe can be composed of a metal material or a plastic. The fastening ring can also be composed of a metal material or a plastic. The same basically applies to the filling head, in particular to a tubular section of the filling head.

An exemplary embodiment of the invention is explained in more detail below with reference to figures, in which, schematically:

FIG. 1 shows a perspective view of a filling apparatus according to the invention,

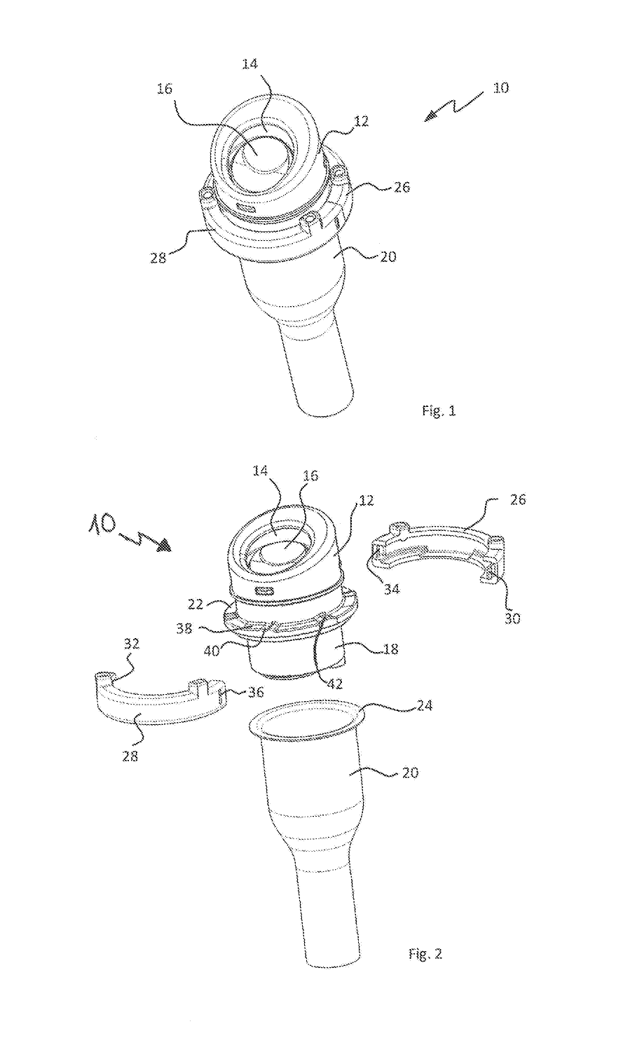

FIG. 2 shows a perspective exploded view of the filling apparatus from FIG. 1,

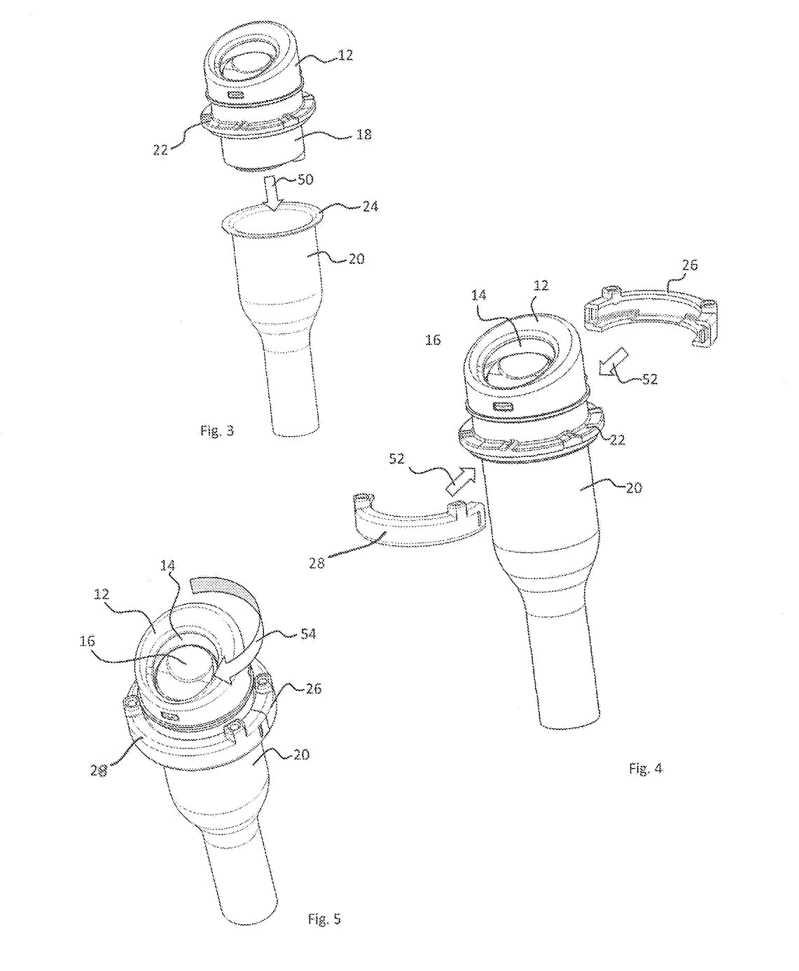

FIG. 3 shows a perspective view of parts of the filling apparatus, which is shown in FIG. 1, in a first mounting state,

FIG. 4 shows a perspective view of parts of the filling apparatus, which is shown in FIG. 1, in a second mounting state,

FIG. 5 shows a perspective view of parts of the filling apparatus, which is shown in FIG. 1, in a third mounting state,

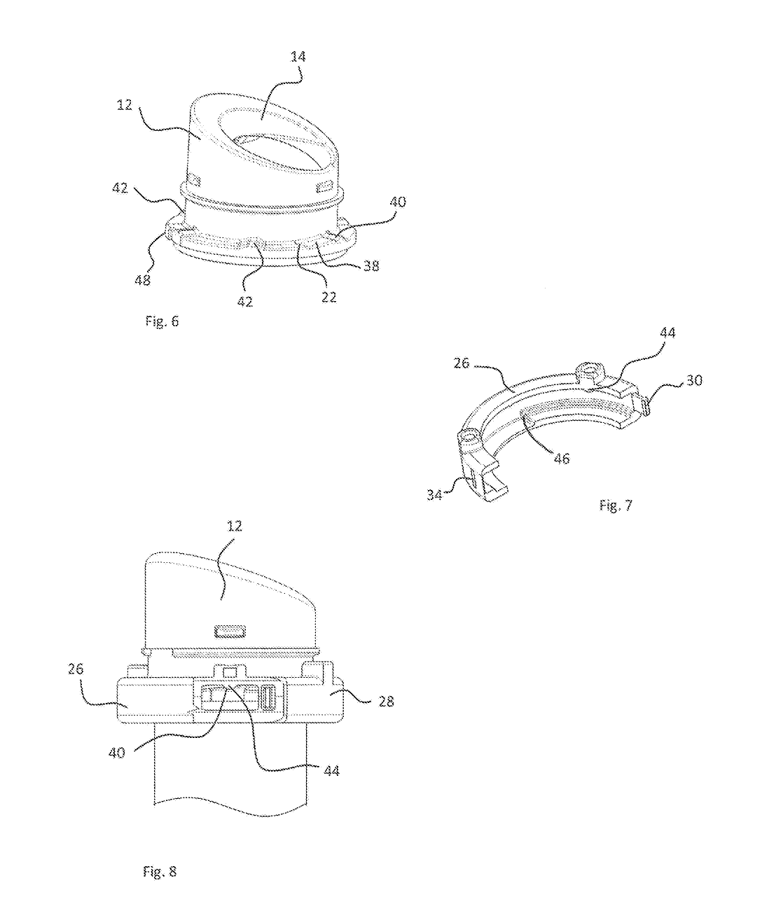

FIG. 6 shows a perspective view of the filling head of the filling apparatus shown in FIG. 1,

FIG. 7 shows a perspective view of part of the fastening ring of the filling apparatus shown in FIG. 1, and

FIG. 8 shows a partially sectioned perspective view of the filling head from FIG. 6 with the fastening ring mounted thereon.

Unless otherwise stated, identical reference numbers denote the same objects in the figures. The filling apparatus 10 shown in FIGS. 1 and 2 serves for filling a vehicle tank with liquid, for example with fuel. The filling apparatus comprises a filling head 12, a capless filling head 12 in the example illustrated. The filling head 12 has a filling opening 14 into which a fuel pump nozzle can be introduced and hooked in place. A pivotably mounted flap 16 which is prestressed in a manner known per se into the closed position shown in the figures is arranged in the region of the filling opening 14. Said flap is opened during the introduction of a fuel pump nozzle. At its end opposite the filling opening 14, the filling head 12 has a tubular section 18 which is inserted into a filling pipe 20 connected to the vehicle tank (not shown). The filling pipe 20 and the vehicle tank can be part of the filling apparatus 10 according to the invention. Between the opposite ends of the filling head 12, the latter has an encircling fastening flange 22 on its outer side. The filling pipe 20 likewise has a fastening flange 24 at its end facing the filling head 12. In the state of the tubular section 18 in which the latter is inserted into the filling pipe 20, the fastening flange 22 of the filling head 12 bears against the fastening flange 24 of the filling pipe 20.

The filling apparatus 10 according to the invention furthermore has a fastening ring which is formed from two ring halves 26, 28 which, in the example shown, are of identical configuration and are in the form of half shells. The ring halves 26, 28 in each case have a U-shaped cross section. The ring halves 26, 28 have in each case one latching lug 30, 32 at their one free end and one latching receptacle 34, 36 at their other free end (also see the enlarged illustration in FIG. 7). The ring halves 26, 28 can be correspondingly brought from an open position, in which they are separate from each other, into a pre-closure position, in which the latching lugs 30, 32 are received in a latching manner in the latching receptacles 34, 36 and the ring halves 26, 28 form a closed fastening ring. The fastening flange 22 of the filling head 12 and the fastening flange 24 of the filling pipe 20 are received and held here in the U-shaped profile of the ring halves 26, 28.

It can be seen in the enlarged illustration of FIG. 6 that the fastening flange 22 of the filling head 12 firstly has, on its upper side which, in the mounted state, faces away from the fastening flange 24 of the filling pipe 20, a plurality of pressing ramps 38 which in each case lead into one locking recess 40. In the example illustrated, three uniformly distributed pressing ramps 38 and locking recesses 40 are arranged over the circumference of the fastening flange 22. Furthermore, in the example shown, a total of three pressing cams 42 are formed in each case between two pressing ramps 38 on the upper side of the fastening flange 22. The ring halves 26, 28 have corresponding locking projections 44 on their inner surface, which, in the mounted state, faces the upper side of the fastening flange 22 of the filling head 12 (see, for example, FIG. 7), optionally likewise in conjunction with suitable pressing ramps. In addition, a stop which is likewise provided on the two ring halves 26, 28 can be seen at the reference number 46 in FIG. 7. In the mounted state, the stops 46 of the ring halves 26, 28 interact with corresponding stops of the fastening flange 22 of the filling head 12, of which one can be seen at reference number 48 in FIG. 6.

The mounting of the filling apparatus according to the invention will be explained with reference to FIGS. 3 to 5. In a first mounting step, the filling head 12 is inserted with the tubular section 18 thereof into the filling pipe 20, as illustrated by the arrow 50 in FIG. 3. Subsequently, the two ring halves 26, 28 are connected to each other in a latching manner from the outside and with the fastening flanges 22, 24 being accommodated, as shown by the arrows 52 in FIG. 4.

From this pre-closure position, the fastening ring formed from the ring halves 26, 28 is rotated relative to the filling head 12 and the filling pipe 20, as shown by the arrow 54 in FIG. 5. The rotation is possible until the stops 46, 48 are reached. In the process, the above-explained pressing ramps 38 and locking recesses 40, on the one hand, and the above-explained locking projections 44, on the other hand, interact in the manner of a bayonet closure, wherein the fastening flanges 22, 24 of filling head 12 and filling pipe 20 are pressed against each other. The pressing effect is further reinforced by the pressing cams 42 which bear in a pressing manner against corresponding mating surfaces of the ring halves 26, 28. As can be seen in particular in the section in FIG. 8, the locking projections 44 of the ring halves 26, 28 are received in the corresponding locking recesses 40 of the fastening flange 22 in the closed position.

Furthermore, a sealing ring can be arranged between the fastening flanges 22, 24, said sealing ring being compressed during the closing of the bayonet closure and therefore sealing the passage between filling head 12 and filling pipe 20 against an escape of liquid and/or gas.

1. A filling apparatus for a vehicle tank, comprising a filling head, through which a liquid to be filled into the vehicle tank can be filled and on the outer side of which a fastening flange is provided, wherein a fastening device is provided, by way of which the filling head can be fastened releasably to a filling pipe which is connected to the vehicle tank, the fastening device comprising a fastening ring which is formed from two ring halves, it being possible for the ring halves to be adjusted between an open position and a closed position, the ring halves holding the fastening flange of the filling head and a fastening flange of the filling pipe between them in the closed position, and the ring halves releasing the fastening flange of the filling head and the fastening flange of the filling pipe in the open position for releasing the filling head from the filling pipe.

2. The filling apparatus as claimed in claim 1, wherein the ring halves press the fastening flange of the filling head and the fastening flange of the filling pipe against one another in the closed position.

3. The filling apparatus as claimed in claim 1, wherein the ring halves in each case have a U-shaped cross section.

4. The filling apparatus as claimed in claim 1, wherein the ring halves can be connected to one another by a latching connection.

5. The filling apparatus as claimed in claim 4, wherein the ring halves comprise in each case one latching lug which is formed at their one free end and in each case one latching receptacle which is formed at their other free end, the latching lugs being received in a latching manner in the latching receptacles in order to connect the ring halves.

6. The filling apparatus as claimed in claim 1, wherein the ring halves are connected to one another pivotably.

7. The filling apparatus as claimed in claim 4, wherein one of the ring halves has a latching lug at its free end, and wherein the other of the ring halves has a latching receptacle at its free end, in which latching receptacle the latching lug can be received in a latching manner in order to connect the ring halves.

8. The filling apparatus as claimed in claim 1, wherein the ring halves are of identical configuration.

9. The filling apparatus as claimed in claim 1, wherein the ring halves interact in the closed position in the manner of a bayonet closure with the fastening flange of the filling head and/or the fastening flange of the filling pipe.

10. The filling apparatus as claimed in claim 9, wherein the ring halves have at least one pressing ramp with at least one locking recess which adjoins the at least one pressing ramp, and wherein the fastening flange of the filling head and/or the fastening flange of the filling pipe have/has at least one locking projection which is received in the at least one locking recess in the closed position.

11. The filling apparatus as claimed in claim 9, wherein the fastening flange of the filling head and/or the fastening flange of the filling pipe have/has at least one pressing ramp with at least one locking recess which adjoins the at least one pressing ramp, and wherein the ring halves have at least one locking projection which is received in the at least one locking recess in the closed position.

12. The filling apparatus as claimed in claim 9, wherein the ring halves have at least one pressing cam which is pressed against the fastening flange of the filling head and/or the fastening flange of the filling pipe in the closed position, and/or wherein the fastening flange of the filling head and/or the fastening flange of the filling pipe have/has at least one pressing cam which is pressed against the ring halves in the closed position.

13. The filling apparatus as claimed in claim 1, wherein a seal is arranged between the fastening flange of the filling head and the fastening flange of the filling pipe at least in the closed position.

14. The filling apparatus as claimed in claim 1, wherein the filling head is a filling head with a closure cap or a capless filling head.

15. The filling apparatus as claimed in claim 1, wherein the filling pipe is composed of a metal material or a plastic, and/or wherein the fastening ring is composed of a metal material or a plastic.
